(19) United States
(12) Patent Application Publication
(10) Pub. No.: US 2013/0139654 A1
(43) Pub. Date: Jun. 6, 2013

(54) WRENCH TOOL WITH A RETAINING DEVICE

(71) Applicant: Wei-Lin Chen, Taichung (TW)

(72) Inventor: Wei-Lin Chen, Taichung (TW)

(21) Appl. No.: 13/309,355

(22) Filed: Dec. 1, 2011

(51) Int. Cl. B25B 13/46; B25B 23/10

(52) U.S. Cl. 81/60; 81/125

(57) ABSTRACT

A wrench tool with a retaining device contains a body including a receiving cavity formed on at least one end thereof; a ratchet seat received in the receiving cavity of the body and including a plurality of teeth arranged around an outer surface thereof and a polygonal fitting segment fixed around an inner surface thereof, the fitting segment including a plurality of odd interior angles and a number of even interior angles, and between two adjacent interior angles of the fitting segment being provided with an adjoining wall, and the adjoining wall including two contacting faces formed on two sides thereof respectively; a ratchet device defined between the body and the ratchet seat and engaging with the teeth of the ratchet seat; a retaining device including a flexible engaging assembly disposed on the adjoining wall and extending over the two contacting faces.

### BACKGROUND OF THE INVENTION

1. Field of the Invention

The present invention relates to a wrench tool with a retaining device that is capable of retaining a workpieces securely by using an adjoining wall between two adjacent interior angles of a fitting segment.

2. Description of the Prior Arts

As shown in FIGS. 1 and 2, a conventional wrench 10 with a retaining device disclosed in TW Pat. No. 90224805 includes a polygonal fitting orifice 11 disposed on one end thereof, the fitting orifice 11 includes a receiving cavity 12 fixed on an inner surface thereof and having a flexible C-shaped retainer 13 so that the wrench 10 is fitted with a hexagonal workpiece 14 by using a plurality of odd interior angles or a number of even interior angles; however as an internal side of the C-shaped retainer 13 extends over the fitting orifice 11 excessively, a head end of the workpiece 14 does not push the C-shaped retainer 13 away, and as the internal side of the C-shaped retainer 13 extends over the fitting orifice 11 slightly, it does not retain the workpiece. In addition, when the workpiece 14 is fitted with the wrench 10, six vertex angles of the workpiece 14 abut against the C-shaped retainer 13, so that one part of the C-shaped retainer 13 close to an opening of the C-shaped retainer 13 becomes deformable, yet the other parts of the C-shaped retainer 13 far away from the opening of the C-shaped retainer 13 does not become deformable, hence the workpiece 14 can not fit with the wrench 10 easily, and the C-shaped retainer 13 engages with the six vertex angles of the workpiece 14, so the workpiece 14 can not be retained securely.

Referring to FIGS. 3 and 4, a conventional wrench 20 with a retaining device disclosed in TW Pat. No. 91210452 includes a driving head 21 disposed on one end thereof, the driving head 21 includes a polygonal receiving cavity 22, wherein the receiving cavity 22 includes a plurality of vertex-angle positions to receive a number of flexible balls 23 individually, and the flexible ball 23 is used to retain a hexagonal workpiece 24. As shown in FIG. 4, if the flexible ball 23 is located at one of the vertex-angle positions of odd interior angles of the receiving cavity 22, the workpiece 24 contacts with the odd interior angles of the receiving cavity 22 so that the flexible ball 23 engages with the workpiece 24. As illustrated in FIG. 5, if the workpiece 24 engages with even interior angles of the receiving cavity 22, the flexible ball 23 does not correspond to any one of vertex angles of the workpiece 24, and the workpiece 24 can not be retained completely.

With reference to FIGS. 6 and 7, a socket tool 30 disclosed in TW Pat. No. 92211267 includes a hexagonal section 31 with a through aperture 32 in which a ball 33 is fixed and a C-shaped retainer 34 used to push the ball 33. Since the ball 33 and the C-shaped retainer 34 are fixed in the socket tool 30, when a wrench 35 is fitted with the socket tool 30 by using odd interior angles or even interior angles of the socket tool 30, the ball 33 and the C-shaped retainer 34 are used to retain a workpiece. Nevertheless, each one of different-size socket tools 30 has to match with a set of ball 33 and C-shaped retainer 34, having high production cost.

The present invention has arisen to mitigate and/or obviate the afore-described disadvantages.

### SUMMARY OF THE INVENTION

The primary object of the present invention is to provide a wrench tool with a retaining device in which a body includes a polygonal fitting segment fixed around an inner surface thereof, and a retaining device includes a flexible engaging assembly disposed on an adjoining wall between two adjacent interior angles of the fitting segment and extends over two contacting faces formed on two sides of the adjoining wall respectively so that when the fitting segment is fitted with a hexagonal workpiece, the odd interior angles or the even interior angles is capable of retaining with the workpiece securely.

Further object of the present invention is to provide a wrench tool with a retaining device in which the flexible engaging assembly is disposed on the adjoining wall between the two adjacent interior angles of the fitting segment and extends over the two contacting faces formed on the two sides of the adjoining wall respectively so that when the polygonal fitting segment is fitted with the hexagonal workpiece, the flexible engaging assembly engages with an outer surface of the workpiece instead of engaging with a vertex angle, such that the fitting segment is fitted with the workpiece easily.

Another object of the present invention is to provide a wrench tool with a retaining device in which the flexible engaging assembly is disposed on the fitting segment so that the wrench tool is capable of matching with different sizes of workpieces without providing an additional retaining device to lower a production cost.

### BRIEF DESCRIPTION OF THE DRAWINGS

FIG. 1 is a perspective view of a conventional wrench with a retaining device disclosed in TW Pat. No. 90224805;

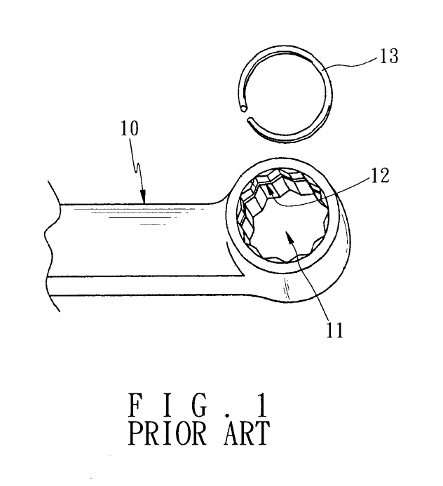

FIG. 2 is a plan view showing the operation of the conventional wrench with the retaining device disclosed in TW Pat. No. 90224805;

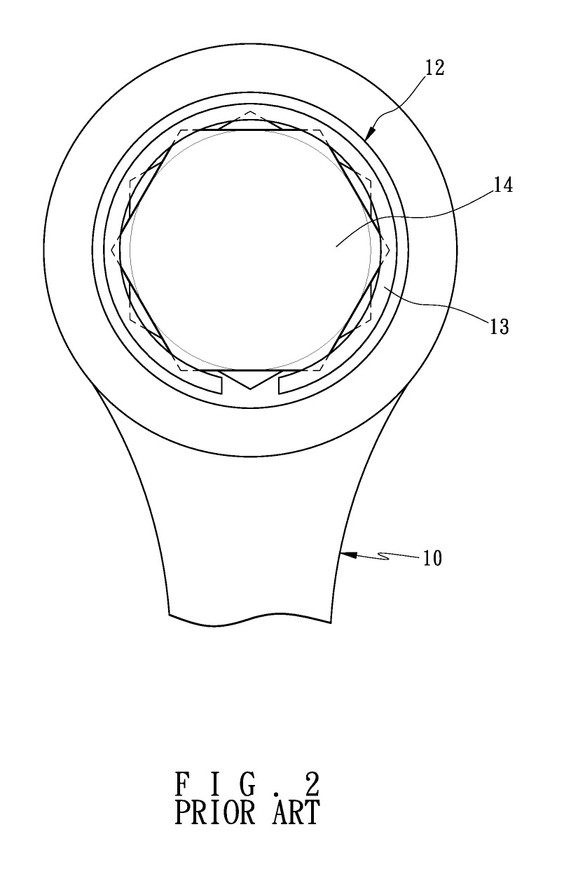

FIG. 3 is a perspective view of a conventional wrench tool with a retaining device disclosed in TW Pat. No. 91210452;

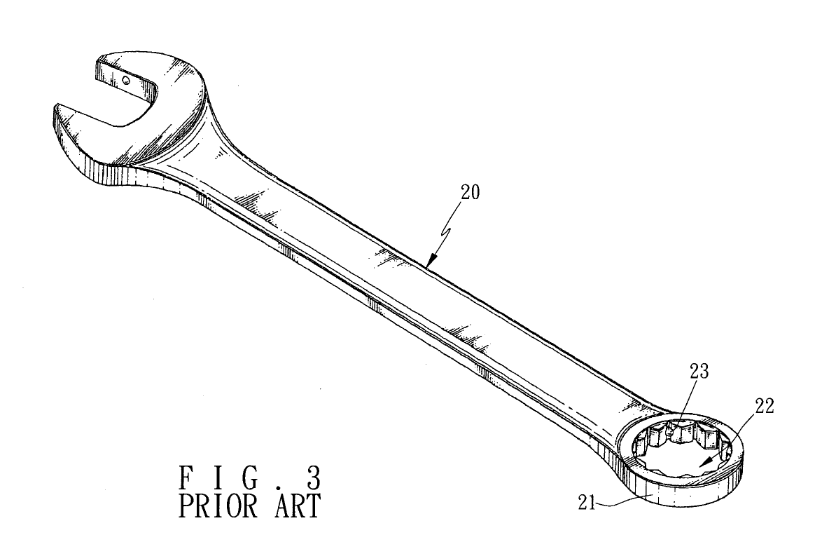

FIG. 4 is a plan view showing the operation of the conventional wrench tool with the retaining device disclosed in TW Pat. No. 91210452;

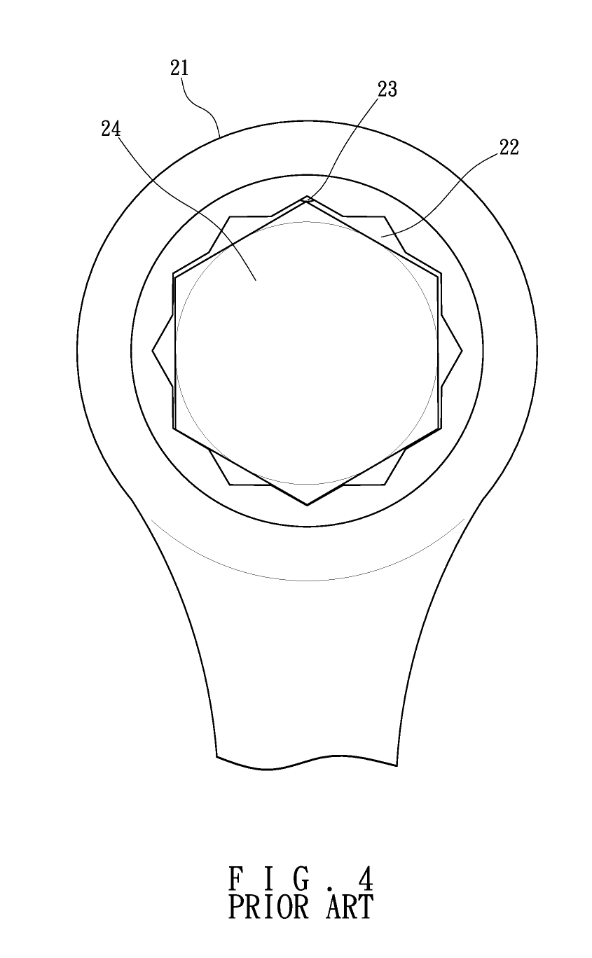

FIG. 5 is another plan view showing the operation of the conventional wrench tool with the retaining device disclosed in TW Pat. No. 91210452;

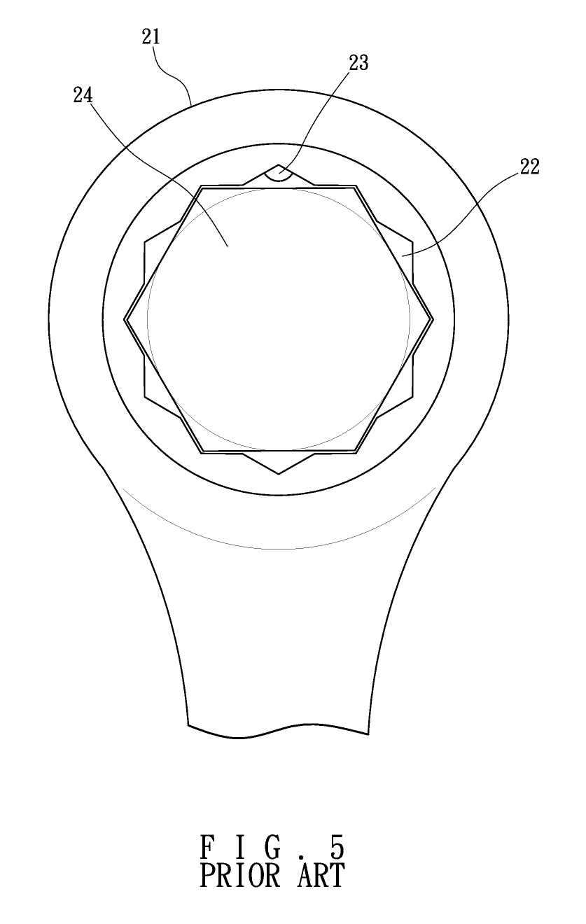

FIG. 6 is a perspective view showing the exploded components of a conventional wrench tool with a retaining device disclosed in TW Pat. No. 92211267;

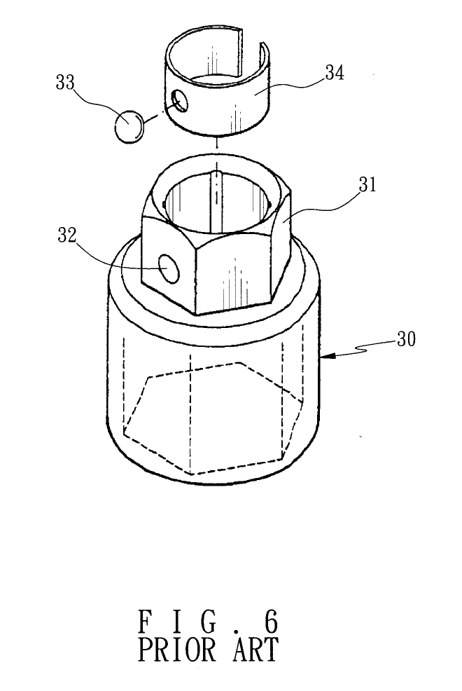

FIG. 7 is a plan view showing the operation of the conventional wrench tool with the retaining device disclosed in TW Pat. No. 92211267;

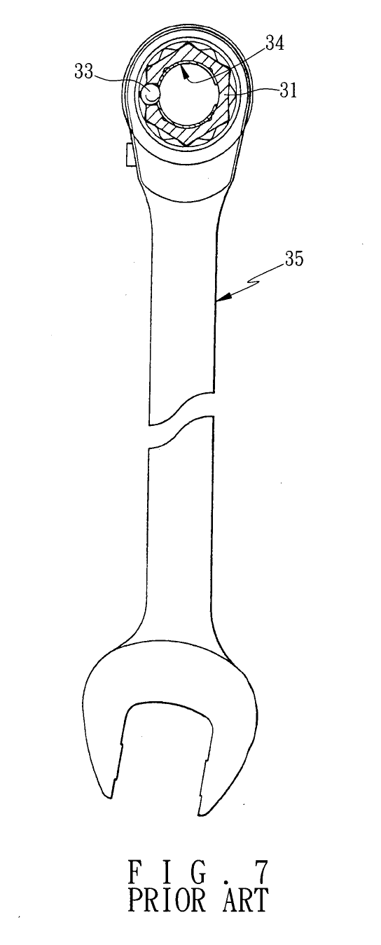

FIG. 8 is a perspective view showing the exploded components of a wrench tool with a retaining device according to a first embodiment of the present invention;

FIG. 9 is a perspective view showing the assembly of the wrench tool with the retaining device according to the first embodiment of the present invention;

FIG. 10 is a cross sectional view showing the operation of the wrench tool with the retaining device according to the first embodiment of the present invention;

FIG. 11 is another cross sectional view showing the operation of the wrench tool with the retaining device according to the first embodiment of the present invention;

FIG. 12 is a perspective view showing the exploded components of a wrench tool with a retaining device according to a second embodiment of the present invention;

FIG. 13 is a perspective view showing the assembly of the wrench tool with the retaining device according to the second embodiment of the present invention;

FIG. 14 is a cross sectional view showing the operation of the wrench tool with the retaining device according to the second embodiment of the present invention;

FIG. 15 is another cross sectional view showing the operation of the wrench tool with the retaining device according to the second embodiment of the present invention.

### DETAILED DESCRIPTION OF THE PREFERRED EMBODIMENT

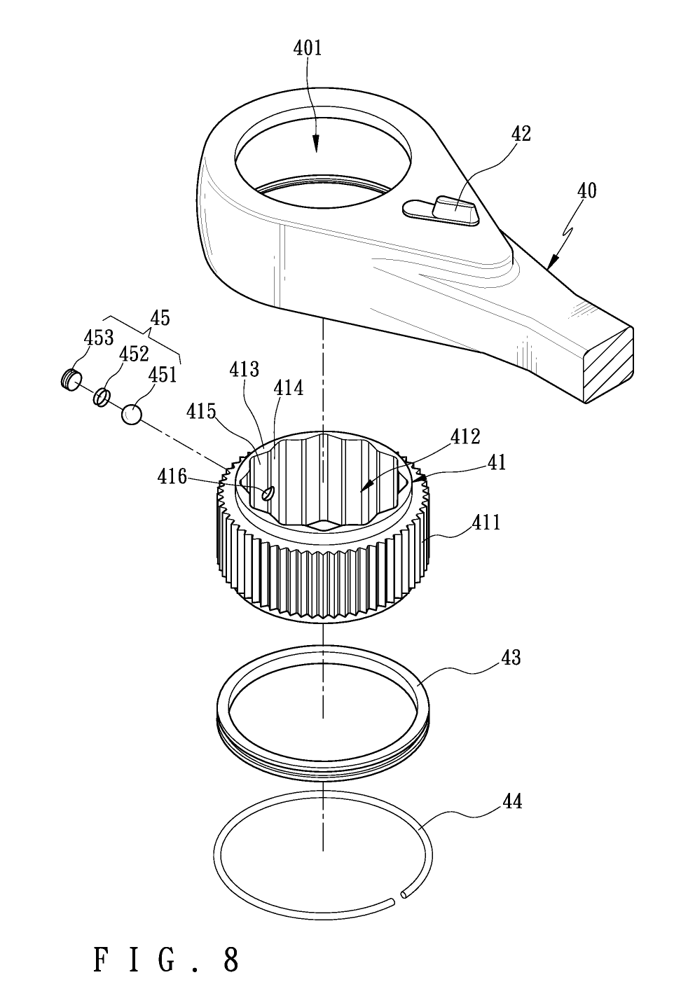

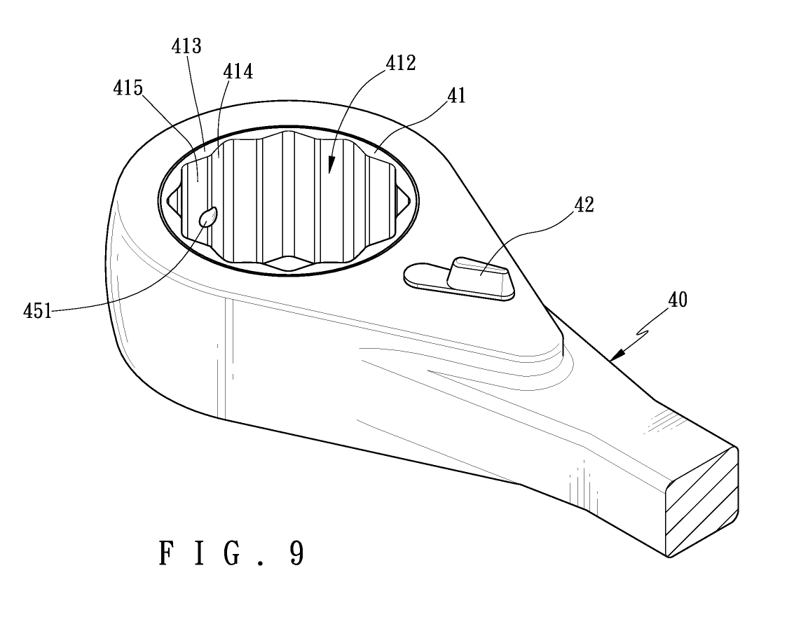

Referring to FIGS. 8 and 9, a wrench tool according to a first embodiment of the present invention is a ratchet wrench and includes a body 40, the body 40 includes a receiving cavity 401 formed on at least one end thereof and having a ratchet seat 41 received in the receiving cavity 401, the ratchet seat 41 includes a plurality of teeth 411 arranged around an outer surface thereof and a polygonal fitting segment 412 fixed around an inner surface thereof, the fitting segment 412 includes odd interior angles and even interior angles, wherein the odd interior angles includes a first angle, a third angle, a fifth angle, a seventh angle, a ninth angle, and an eleventh angle, the even interior angles includes a second angle, a fourth angle, a sixth angle, an eighth angle, a tenth angle, and a twelfth angle; a ratchet device 42 is defined between the body 40 and the ratchet seat 41 and engages with the teeth 411 of the ratchet seat 41. Because the ratchet device 42 is a well-know art, further remarks will be omitted. The ratchet seat 41 is placed in the receiving cavity 401 of the body 40 and then is fixed by a cover 43 and a C-shaped retainer 44; wherein the ratchet seat 41 includes a retaining device 45 mounted thereon, and between two adjacent interior angles of the fitting segment 412 of the ratchet seat 41 is provided with an adjoining wall 413, the adjoining wall 413 includes two contacting faces 414, 415 formed on two sides thereof respectively, the retaining device 45 includes a blind hole 416 disposed on the adjoining wall 413 and connecting with the two contacting faces 414, 415, the blind hole 416 includes a flexible engaging assembly fixed therein and having a ball 451, a resilient element 452 abutting against the ball 451, and a bolt element 453, wherein a diameter of a distal end of the blind hole 416 is less than that of the ball 451 so that the ball 451 does not disengage from the blind hole 416 and extends over the two contacting faces 414, 415 partially.

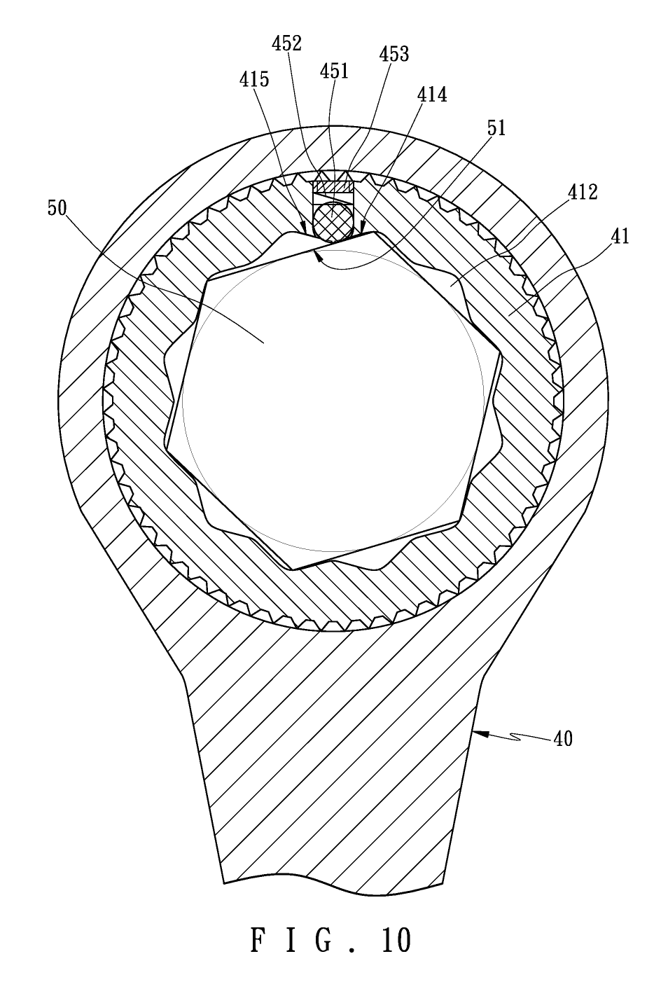

As shown in FIG. 10, when a hexagonal workpiece 50 (such as a screw bolt, a nut, or a socket) is fitted onto the odd interior angles of the fitting segment 412 of the ratchet seat 41, because one of outer faces 51 of the workpiece 50 is in response to the contacting face 414, one part of the ball 451, which extends over the contacting face 414, engages with the one of the outer faces 51 of the workpiece 50 by using the resilient element 452, thereby the hexagonal workpiece 50 is fitted with the ratchet seat 41 easily and securely.

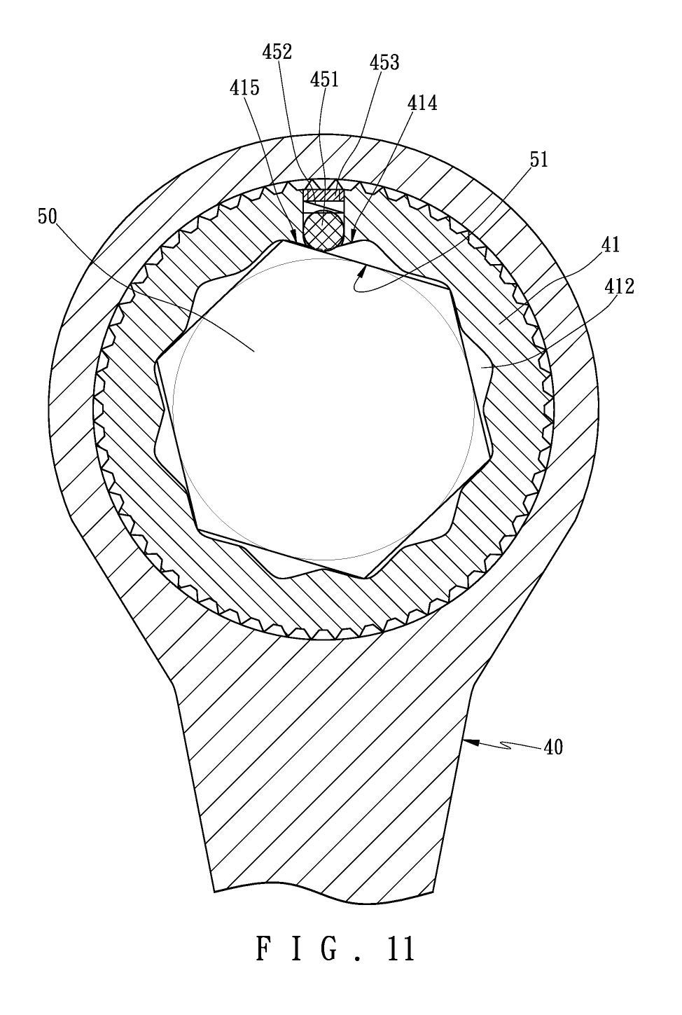

As illustrated in FIG. 11, when the hexagonal workpiece 50 is fitted onto the even interior angles of the fitting segment 412 of the ratchet seat 41, because anther of the outer faces 51 of the workpiece 50 corresponds to the contacting face 415, the one part of the ball 451, which extends over the contacting face 414, engages with the another of the outer faces 51 of the workpiece 50 by using the resilient element 452, thereby the hexagonal workpiece 50 is fitted with the ratchet seat 41 easily and securely.

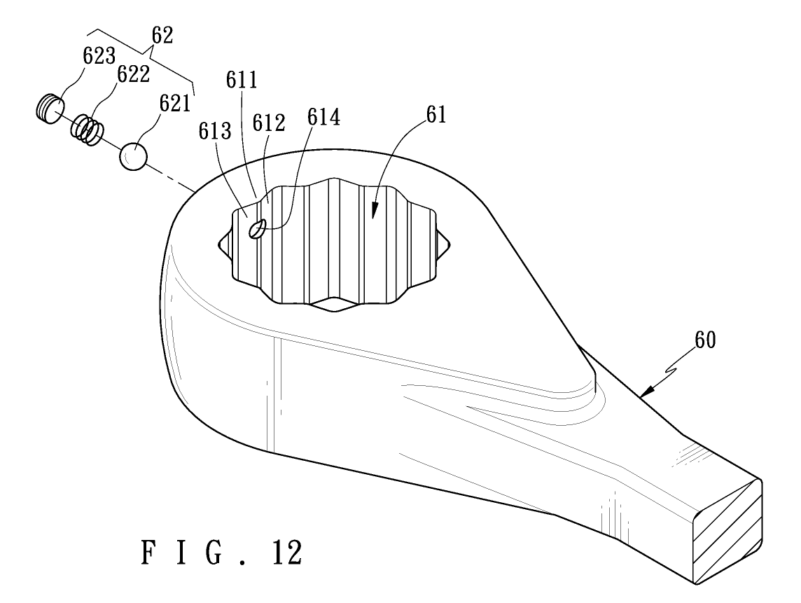

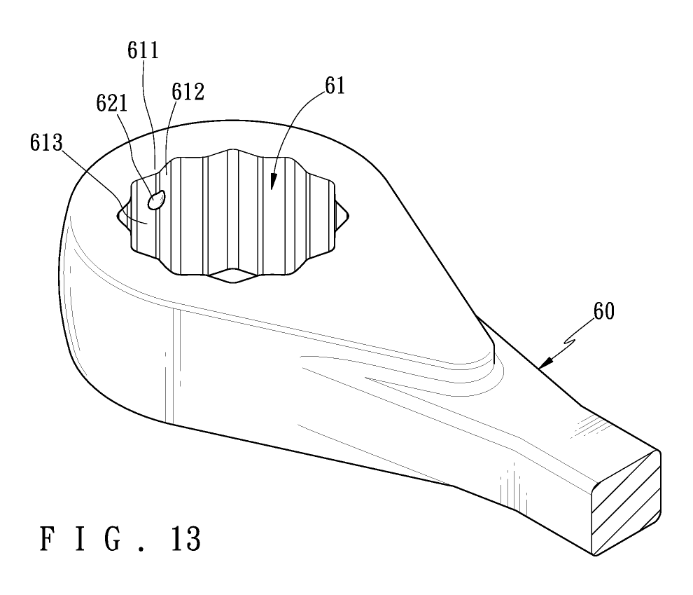

With reference to FIGS. 12 and 13, a wrench tool according to a second embodiment of the present invention is a box wrench and includes a body 60, the body 60 includes a polygonal fitting segment 61 fixed on at least one end thereof, the fitting segment 61 includes odd interior angles and even interior angles; wherein the odd interior angles includes a first angle, a third angle, a fifth angle, a seventh angle, a ninth angle, and an eleventh angle, the even interior angles includes a second angle, a fourth angle, a sixth angle, an eighth angle, a tenth angle, and a twelfth angle; wherein the fitting segment 61 includes a retaining device 62 mounted thereon, and between two adjacent interior angles of the fitting segment 61 is provided with an adjoining wall 611, the adjoining wall 611 includes two contacting faces 612, 613 formed on two sides thereof respectively, the retaining device 62 includes a blind hole 614 disposed on the adjoining wall 611 and connecting with the two contacting faces 612, 6135, the blind hole 614 includes a flexible engaging assembly which has a ball 621 placed in the blind hole 614, a resilient element 622 abutting against the ball 621, and a bolt element 623, wherein a diameter of a distal end of the blind hole 614 is less than that of the ball 621 so that the ball 621 does not disengage from the blind hole 614 and extends over the two contacting faces 612, 613 partially.

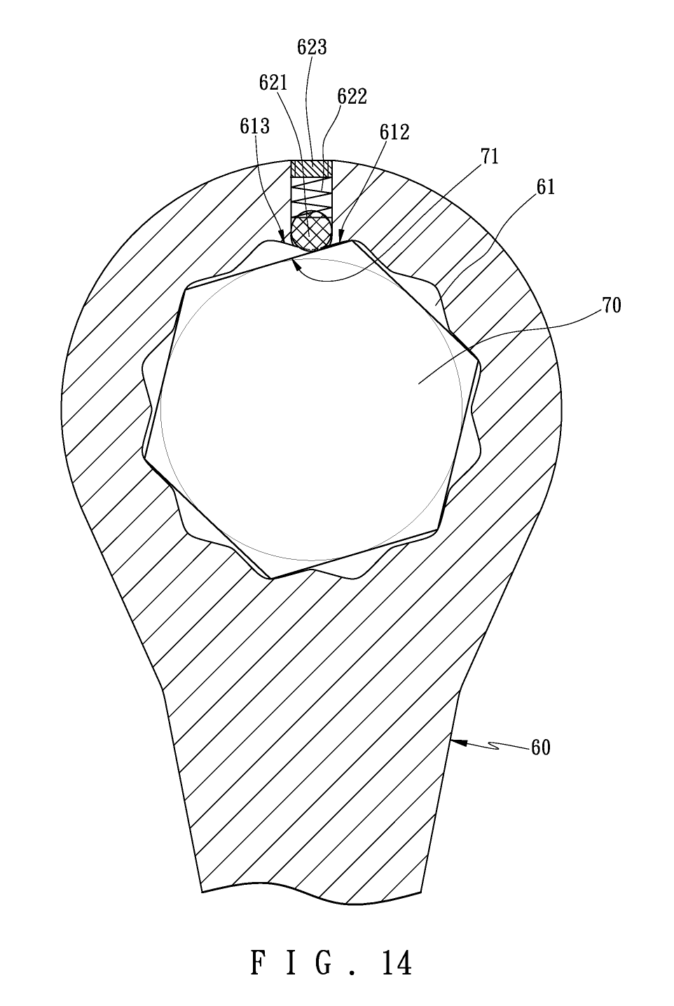

As shown in FIG. 14, when a hexagonal workpiece 70 (such as a screw bolt, a nut, or a socket) is fitted onto the odd interior angles of the fitting segment 61, because one of outer faces 71 of the workpiece 70 is in response to the contacting face 612, one part of the ball 621, which extends over the contacting face 612, engages with the one of the outer faces 71 of the workpiece 70 by ways of the resilient element 622, thereby the hexagonal workpiece 70 is fitted with the fitting segment 61 easily and securely.

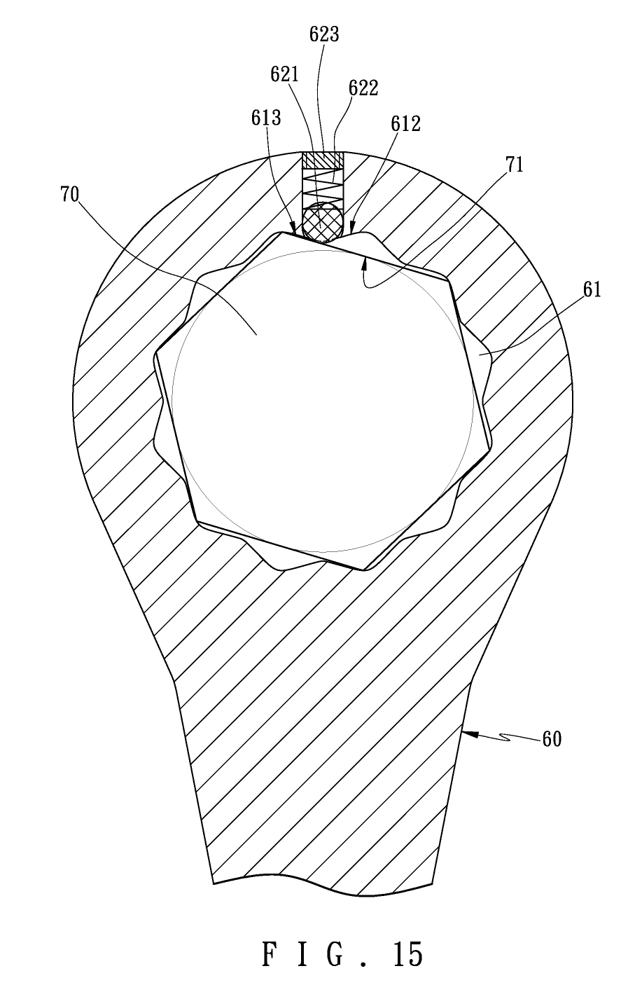

As illustrated in FIG. 15, when the hexagonal workpiece 70 is fitted onto the even interior angles of the fitting segment 61, because anther of the outer faces 71 of the workpiece 70 corresponds to the contacting face 613, the one part of the ball 621, which extends over the contacting face 613, engages with the another of the outer faces 71 of the workpiece 70 by ways the resilient element 622, thereby the hexagonal workpiece 70 is fitted with the fitting segment 61 easily and securely.

The invention is not limited to the above embodiment but various modifications thereof may be made. It will be understood by those skilled in the art that various changes in form and detail may made without departing from the scope and spirit of the present invention.

What is claimed is:

1. A wrench tool with a retaining device comprising:
a body including a receiving cavity formed on at least one end thereof;
a ratchet seat received in the receiving cavity of the body and including a plurality of teeth arranged around an outer surface thereof and a polygonal fitting segment fixed around an inner surface thereof, the fitting segment including a plurality of odd interior angles and a number of even interior angles, and between two adjacent interior angles of the fitting segment being provided with an adjoining wall, and the adjoining wall including two contacting faces formed on two sides thereof respectively;
a ratchet device defined between the body and the ratchet seat and engaging with the teeth of the ratchet seat;
a retaining device including a flexible engaging assembly disposed on the adjoining wall and extending over the two contacting faces.

2. The wrench tool with the retaining device as claimed in claim 1, wherein the odd interior angles includes a first angle, a third angle, a fifth angle, a seventh angle, a ninth angle, and an eleventh angle, the even interior angles includes a second angle, a fourth angle, a sixth angle, an eighth angle, a tenth angle, and a twelfth angle.

3. The wrench tool with the retaining device as claimed in claim 1, wherein the ratchet seat is placed in the receiving cavity of the body and then is fixed by a cover and a C-shaped retainer.

4. The wrench tool with the retaining device as claimed in claim 1, wherein the retaining device includes a blind hole disposed on the adjoining wall and connecting with the two contacting faces, the blind hole includes the flexible engaging assembly fixed therein.

5. The wrench tool with the retaining device as claimed in claim 4, wherein the flexible engaging assembly has a ball, a resilient element abutting against the ball, and a bolt element.

6. The wrench tool with the retaining device as claimed in claim 5, wherein a diameter of a distal end of the blind hole is less than that of the ball.

7. A wrench tool with a retaining device comprising:
a body including a polygonal fitting segment fixed on at least one end thereof, the fitting segment including a plurality of odd interior angles and a number of even interior angles, and between two adjacent interior angles of the fitting segment being provided with an adjoining wall, the adjoining wall including two contacting faces formed on two sides thereof respectively;
a retaining device including a flexible engaging assembly disposed on the adjoining wall and extending over the two contacting faces.

8. The wrench tool with the retaining device as claimed in claim 7, wherein the odd interior angles includes a first angle, a third angle, a fifth angle, a seventh angle, a ninth angle, and an eleventh angle, the even interior angles includes a second angle, a fourth angle, a sixth angle, an eighth angle, a tenth angle, and a twelfth angle.

9. The wrench tool with the retaining device as claimed in claim 7, wherein the retaining device includes a blind hole disposed on the adjoining wall and connecting with the two contacting faces, the blind hole includes the flexible engaging assembly fixed therein.

10. The wrench tool with the retaining device as claimed in claim 9, wherein the flexible engaging assembly has a ball, a resilient element abutting against the ball, and a bolt element, a diameter of a distal end of the blind hole is less than that of the ball.
